(19) United States
(12) Patent Application Publication
(10) Pub. No.: US 2008/0126752 A1
(43) Pub. Date: May 29, 2008

(54) Dual-processor communication

(76) Inventors: Steven T. Baker, Salt Lake City, UT (US); Douglas J. Kogan, Sandy, UT (US); Benjamin A. Kendall, Boise, ID (US); Jason D. Carnahan, Boise, ID (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/497,715

(22) Filed: Aug. 2, 2006

(51) Int. Cl. G06F 15/76; G06F 9/06

(52) U.S. Cl. 712/31; 712/E09.003

(57) ABSTRACT

A method for dual-processor communication. In one example embodiment, a method includes indicating to a master processor that data is available to transfer to the master processor; receiving a request for the data from the master processor over a storage-based channel; and sending the data to the master processor over the storage-based channel. In another embodiment a method includes determining that data is available for transfer from a slave processor; sending a request for the data to the slave processor over a storage-based channel; and receiving the data from the slave processor over the storage-based channel. In another embodiment a method includes detecting an event on a master processor and writing data corresponding to the event to a slave processor over a storage-based channel.

### BACKGROUND

Computers and computing systems have affected nearly every aspect of modern living. Computers are generally involved in work, recreation, healthcare, transportation, entertainment, household management, etc. As computers become more widely used, digital data also becomes more prevalent and more desirable. For example, digital data can be used to represent audio and video signals. Music on CDs is stored digitally. Audio and video on DVDs is also stored digitally. Television signals provided over cable and satellite systems is generally provided in a digital format. In many areas, digitally encoded television signals can even be received from traditional over the air (OTA) broadcasters that have previously only broadcast analog signals.

Because this data can be stored digitally, individuals have begun using media servers where audio, video, and image data is stored on a computer system, central server or other central storage. This allows the user to have a repository of multimedia data. The user can then play or display the multimedia data directly from the computer, or send the data over the network to another computer or media player through a network connection.

Media players which include dual processors may require the ability for the dual processors to communicate with each other. This inter-processor communication is typically accomplished use serial communication, such as RS232. Serial communication, however, can be relatively slow. Slow inter-processor communication can affect the overall performance of a dual-processor media player.

The subject matter claimed herein is not limited to embodiments that solve any disadvantages or that operate only in environments such as those described above. Rather, this background is only provided to disclose one exemplary technology area where some embodiments described herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention may include methods for dual-processor communication. Current embodiments provide the ability for data to be communicated between a master processor and a slave processor. The data can include, for example, status information, control information, hardware settings information, firmware update information, content data, directory information, and/or rendering directives. For example, in one embodiment a method includes indicating to a master processor that data is available to transfer to the master processor, receiving a request for the data from the master processor over a storage-based channel, and sending the data to the master processor over the storage-based channel. In another embodiment a method includes determining that data is available for transfer from a slave processor, sending a request for the data to the slave processor over a storage-based channel, and receiving the data from the slave processor over the storage-based channel. In another embodiment a method includes detecting an event on a master processor and writing data corresponding to the event to a slave processor over a storage-based channel.

Embodiments of the present invention may also include an inter-processor message block message. Current embodiments of the inter-processor message block message provide an extensible communication language for transferring data, commands, status information and the like in a system having dual processors connected by a storage device type bus. For example, in one embodiment an inter-processor message block message includes a virtual first data structure. The virtual first data structure includes a channel field designating a storage-based channel over which the associated message is transferred. The virtual first data structure includes a length field designating the length of a payload portion of the message. The virtual first data structure further includes a payload field comprising zero or more bytes of layer two protocol data.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are disclosed in the appended drawings. Understanding that these drawings depict only typical embodiments and are not therefore to be considered to be limiting in scope, embodiments will be described and explained with additional specificity and detail through the use of the accompanying drawings in which:

FIG. 1 discloses an overview of an example system for delivering media content to users;

FIG. 2 discloses a block-diagram of an example media player;

FIGS. 3A and 3B disclose example methods for dual-processor communication;

FIG. 4 discloses an example inter-processor message block protocol; and

FIG. 5 discloses an example asynchronous opcode application environment.

### DETAILED DESCRIPTION OF EXAMPLE EMBODIMENTS

### I. Example System for Delivering Media Content to Users

The example methods disclosed herein can be implemented in a dual processor system, where the dual processors are interconnected via an interface intended for connection to storage devices such as an IDE interface. IDE interfaces are typically used for storage communication as opposed to processor interconnection. A system may include a specialized media decoder processor which includes specialized hardware for decoding and displaying media data, such as audio, video and/or image data. The decoder processor may be connected via an IDE interface, or other storage-based connection, to a network processor that includes functionality for sending and receiving data across a network. By connecting the network processor to the decoder processor through an IDE interface, the network processor can be treated by the decoder processor as an IDE storage device. An emulator can be used to convert storage operations to network and communication operations and vice versa.

The network processor includes an interface for connecting to a network where data can be obtained. For example, the network processor may connect to a server which includes physical storage for storing data. To obtain video or other data, the video decoder processor may send storage device protocol messages across the IDE interface and to the network processor. This is done in a transparent fashion such that the decoder processor treats the network processor as a storage device. The network processor can then obtain data from a server across a network and provide the data to the decoder processor in a fashion similar to how a storage device provides data across an IDE interface. Because data is being obtained by the network processor across a network, network delays may be introduced into the architecture.

Typically, when implementing an IDE interface, it is assumed that the storage device is local to the processor accessing the storage device and that communications take place fairly quickly. However, the network delays described above may result in various difficulties. For example, one particular method of accessing data across an IDE interface involves sending an IDE request. To avoid corruption of data and other difficulties, only a single IDE request should be active at any particular time. When a physical storage device is in near proximity to the processor consuming data from the storage device, there is usually little difficulty due to the speed of the connection between the processor and storage device. Specifically, by the time a following IDE request is made, a previous IDE request will always be completed. However, when network delays are introduced, there may be some difficulty in that longer than expected latencies may exist between the time when an IDE request is issued and when the corresponding data is returned. To counteract these timing difficulties, inter-processor techniques herein described can be used in recovering the system.

An additional difficulty not expected by IDE storage busses relates to conditions when no responses are received. When a processor is connected to an IDE device over a network, loss of network connectivity or loss of network devices or services may result in a condition where there is no response whatsoever from an IDE request. For example, if a network service is instantiated and later shut-down, an IDE request may be issued for retrieving data from the network service where no response will be received because the service is not able to send a response of any kind.

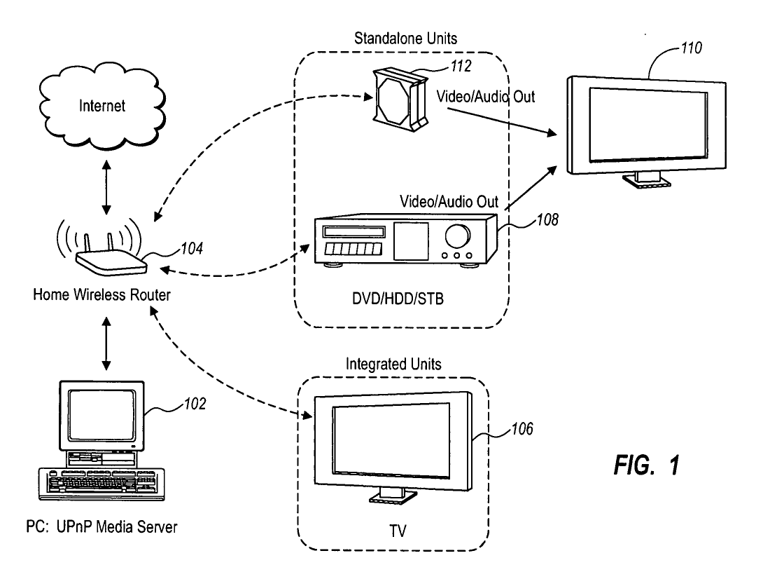

Referring now to FIG. 1, an exemplary environment where some embodiments of the invention may be practiced is disclosed. FIG. 1 discloses a media server 102, which in this example is a universal plug and play (UPnP) server. The media server 102 may store various media files such as music files, video files, and picture files. Generally, the media server 102 is located in a local area network (LAN) and is configured to provide the media files locally to clients. For example, in one embodiment, the media server 102 may be implemented in a home environment to provide media to home users.

In the illustrated embodiment, the media server 102 is connected through a router 104 to various clients in the network. The clients on the network may include specialized media adapters configured to provide media to users. As will be discussed further, the media adapters may include specialized hardware optimized for providing the media to users. For example, the media adapters may include processors that are optimized for decoding compressed audio, video or image data. The media adaptors may be embodied in a number of forms. For example, FIG. 1 disclosed media adapter integrated into a television 106.

FIG. 1 also discloses a number of standalone units. For example, the media adapter may be integrated into a DVD player 108. This embodiment is particularly interesting because the encoding on DVDs is the same as the encoding for stored video files or over the air (OTA) transport streams. Thus, the specialized hardware can be used both for decoding DVD signals as well as decoding data streamed from the media server 102 to the media adapter in the DVD player 108. The DVD player 108 is connected through audio and video connections to a television 110 where the DVD video can be played or where the media data from the media server 102 can be displayed.

FIG. 1 further discloses a self contained media adapter 112. The self contained media adapter 112 includes the specialized hardware for decoding and displaying media streamed from the media server 102. The self contained media adapter 112 is connected to the television 110 through audio and video connections.

Each of the media adapters, whether embodied as an integrated unit or as a standalone unit, is connected, in this example, through the router 104 to the media server 102. The connections between the media server 102, router 104 and media adapters may be any suitable network connection including hardwired Ethernet connections, wireless WiFi connections, or any other suitable connection. Notably, some embodiments described herein optimize wireless network connections to maintain suitability for transmitting high bit rate media files.

### II. Example Media Player

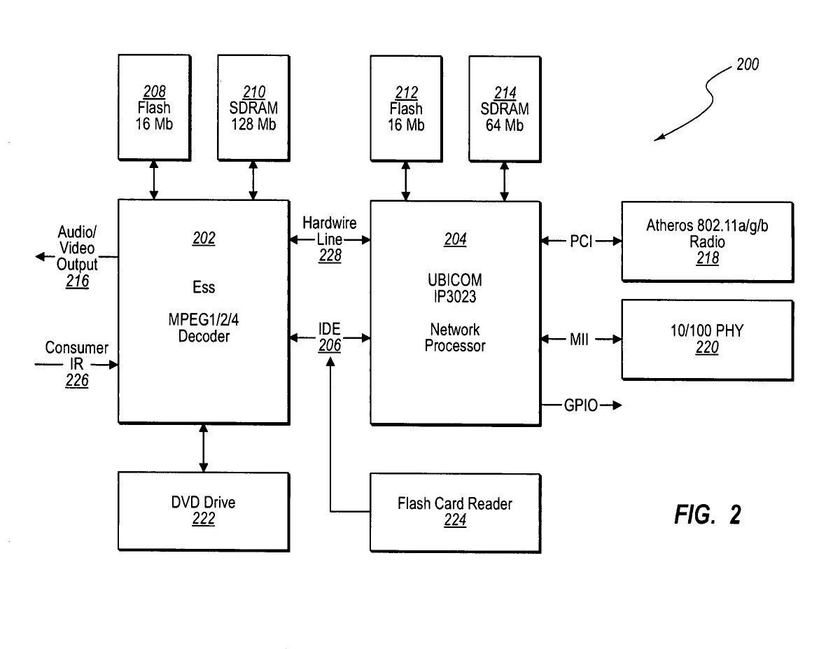

Referring now to FIG. 2, one example of the hardware used to implement a media adapter, designated generally at 200, is disclosed. As described previously, in the illustrated embodiment the media: adapter 200 includes two processors that are coupled by an IDE bus. While an IDE-bus is disclosed here, other storage device type busses may also be used. The media adapter 200 includes an mpeg decoder processor 202 coupled to a network processor 204 through an IDE bus 206. Each of the processors 202, 204 includes other appropriate peripheral hardware depending on the needs of a particular application. For example, in one embodiment the decoder processor 202 is coupled to flash memory 208 and DRAM memory 210. The flash memory and DRAM memory 210 may store computer executable instructions such as computer applications to be executed on the decoder processor 202. Additionally, the DRAM memory 210 may store data from the network processor 204, such as audio, video, or image data. The data stored in the DRAM memory 210 can be displayed by sending audio and video signals through the audio video output line 216. Notably, the audio video output line 216 may be any one of a number of formats including various combinations of composite, component video, HDMI, DVI, and the like.

Similar to the decoder processor 202, the illustrated network processor 204 has a flash memory 212 and a DRAM memory 214 connected to it. The flash memory 212 and DRAM memory 214 are computer readable media that may include computer executable instructions that can be executed by the network processor 204. In addition, the DRAM memory 214 may store data for delivery to the decoder processor 202. For example, the network processor 204 may receive data from a data store such as the media server 102. This data may be stored in the DRAM memory 214 for delivery to the decoder processor 202. Such data may include for example, media, file information, directory information, or other information. In this example, the network processor 204 may be connected to a media server through one or more different network connections.

FIG. 2 discloses both wired and wireless connections. For example, the network processor may be connected through a PCI bus connection to a wireless radio 218. In this example, the wireless radio 218 supports IEEE 802.11a, b, and g wireless signals. IEEE 802.11a and g may be advantageous for video transmission as they are able to handle media streams at higher bit rates than IEEE 802.11b transmissions. The wireless radio 218 may communicate with a wireless router, such as the router 104 shown in FIG. 1. The wireless router 104 can then communicate with the media server 102, either wired or wirelessly, for completing the connection between the network processor 204 and the media server 102.

FIG. 2 further discloses that the network processor 204 may communicate with the media server through a wired connection such as by using a standard 10/100 Mbs (megabits per second) Ethernet adapter, denoted at 220. Similar to the wireless example, the Ethernet adapter 220 may be connected to the router 104, which is in turn connected to the media server 102. While in this example a 10/100 Mbs adapter is used, it should be appreciated that Gigabit Ethernet adapters, or any other suitable adapter, whether wired or wireless, may be used.

FIG. 2 discloses two additional options. The first is a DVD drive 222 connected to the decoder processor 202. As explained previously, often the encoding on DVDs is the same as the encoding for other video and audio files. As such, the specialized hardware on the decoder processor 202 is especially suited for decoding DVD video. As such, a more functional device may be implemented where the device includes a DVD drive 222 such that DVD video can be played from the device. Such a device is disclosed in FIG. 1 at 108.

FIG. 2 discloses a second option, which includes a flash card reader 224 connected to the decoder processor 202 through the IDE bus 206. This option allows users to display media from a portable flash card using the media adapter 200. For example, flash cards from digital cameras or camcorders can be plugged directly into the flash card reader 224 obviating the need to store the media on the media server 102 prior to viewing the media using the media adapter 200. One or more alternatives for the flash card reader 224 may be provided. For example, the flash card reader 224 may have provisions for compact flash, secure digital, multimedia, etc. Additionally, in one embodiment, the flash card reader 224 may include a USB interface for connecting directly to a USB flash storage device or USB connectable hard-disk drive.

Again, in the illustrated example the two processors, the decoder processor 202 and network processor 204, are connected through an IDE bus 206. Ordinarily such communications would take place on a PCI or other type of communication bus. Typically, an IDE bus is used for connecting storage to a processor. However, by using an IDE bus 206 to connect to the decoder processor 202 and network processor 204, several advantages can be realized. For example, typical decoder processors come equipped with a standard IDE bus interface for connecting storage to the decoder processor. However, some decoder processors may not come equipped with network connectivity, and as such may not be suitable on their own for use in a media adapter connectable in a network. By using the IDE bus interface (or similar storage connection-oriented bus interface) to connect through an IDE bus to a network processor, networking functionality can be added to virtually any media decoder processor.

This type of configuration allows for a number of other advantages as well, including: the ability to use a smaller operating system, easier selection of a specialized network processor, easy replacement of the network processor in subsequent designs when additional networking speeds and functionality become available, easy replacement of the decoder processor in subsequent designs, reduced memory requirements, etc.

Ordinarily, a storage device connected to a host processor through an IDE bus is somewhat passive in nature. In other words, an IDE device typically accepts commands from the host processor, and can be polled by the host processor for information, but does not usually provide data to the host processor without first being prompted. In the example shown in FIG. 2, the decoder processor 202 assumes the role of the host processor and the network processor 204 assumes the role of the device in the IDE connection. To facilitate the network processor 204 providing information to the decoder processor 202, in the example embodiment a hardware line 228 connects the two processors. If the network processor 204 has information to pass to the decoder processor 202, the network processor 204 can assert the line signaling to the decoder processor 202 that the network processor 204 has information to pass to the decoder processor 202. The decoder processor 202 can then detect the assertion of the hardware line from the network processor 204 and read the information from the network processor 204. Such information may include, among other things, diagnostic information.

For example, the network processor 204 may be able to detect various conditions such as a storage device not being connected to one of the network connections 218, 220, or the inoperability of the network. The network processor 204 can thus signal on the hardware line 228 that it has data for the decoder processor. When the decoder processor 202 detects the assertion of the hardware line from the network processor 204, the decoder processor 202 can read the diagnostic information from the network processor 204.

In the illustrated example, the particular decoder processor 202 shown is an MPEG1/2/4 decoder, which may be implemented using part numbers ES6425FF, ES8381FCD, or ES643.0FAA available from ESS Technology, Inc. located in Fremont Calif. While any one of a number of different devices/implementations could be used, these particular decoders include various hardware components including a central processing unit, a DMA state machine, an interrupt state machine and a media player state machine. The central processing unit coordinates interactions between the different state machines and generally manages data flow and decoding activities. The DMA state machine manages DMA data requests to perform DMA data handling. The interrupt state machine generally includes a number of registers and indicators indicating active interrupts for obtaining service from the central processing unit from other components including components included in the decoder processor 202. The media player state machine includes functionality for controlling how media is accessed and played for a user. For example, the media player state machine may include functionality for implementing play, pause, fast-forward, rewind, etc. This can be used to control what data is requested, and when the data is requested.

### III. Example Methods for Dual Processor Communication

Systems having dual processors connected by a storage device type bus, such as the media adapter 200 of FIG. 2, may require the ability to communicate data between the two processors. This data can include, for example, status information, control information, hardware settings information, firmware update information, content data, directory information, and/or rendering directives.

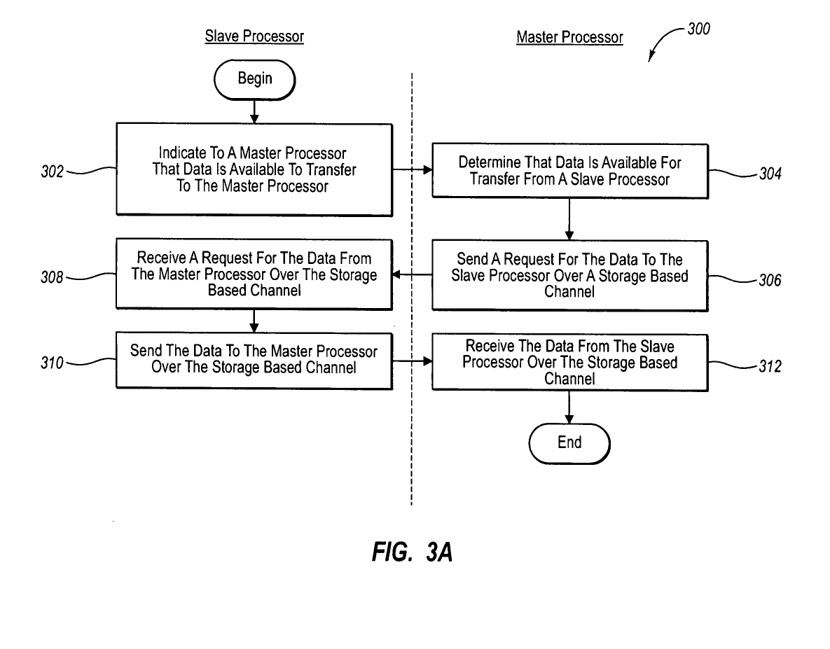

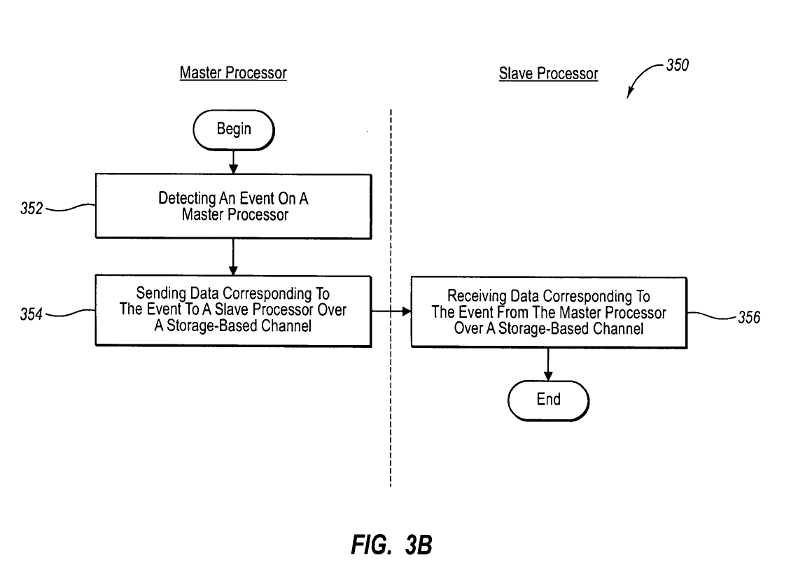

With continued reference to FIGS. 1 and 2, and now also with reference to FIGS. 3A and 3B, example methods for dual-processor communication are disclosed by way of a series of process steps designated at 300 and 350. The methods 300 and 350 of FIGS. 3A and 3B can be implemented in a computing environment similar to FIGS. 1 and 2. More particularly, the methods 300 and 350 can be implemented in a dual-processor computing environment where the processors are connected by a storage device type bus or busses, such as an IDE bus. The methods 300 and 350 are particularly suited to implementation where one processor functions as a master processor and the other processor functions as a slave processor.

For example, the methods 300 and 350 can be implemented in the media adapter 200 of FIG. 2, with the decoder processor 202 functioning as the master processor and the network processor 204 functioning as the slave processor. As disclosed in FIG. 2, the decoder processor 202 and the network processor 204 can communicate data over the IDE bus 206. In addition, the network processor 204 can communicate controls signals to the decoder processor 202 over the hardware line 228.

In the disclosure of the methods 300 and 350 below, various examples of each of the acts of the methods 300 and 350 will be given. It is assumed for the purpose of these examples that the processors 202 and 204 of FIG. 2 are in communication with one or more computer-readable media which carry computer-executable instructions which enable the processors 202 and 204 to perform each of the acts disclosed in connection with the methods 300 and 350.

Method 300 involves communicating information from a slave processor to a master processor. Method 300 includes an act 302 of indicating to a master processor that data is available to transfer to the master processor. For example, the network processor 204 can indicate to the decoder processor 202 that data is available to transfer from the network processor 204 to the decoder processor 202. This indication can be performed in response to an event that changes the data. For example, where the data is status information or control information, the indication can be performed whenever a new status event or control event occurs on the network processor 204.

One example of a status event is a network connectivity status event. A network connectivity status event can occur where network connectivity between the network processor 204 and another network device, such as the media server 102 goes offline or comes online. In either case, the network processor 204 may need to communicate corresponding network connectivity status information to the decoder processor 202 in order for the network connectivity status information to be communicated to a user of the media adapter 200.

The act 302 can include updating one or more emulated files in an emulated file system, where the one or more emulated files contains the data to transfer from the slave processor to the master processor. As disclosed elsewhere herein, since the decoder processor 202 is connected to the network processor 204 through an IDE interface, the network processor 204 can be treated by the decoder processor 202 as an IDE storage device. An emulator can be used to convert storage operations to network and communication operations and vice versa.

Thus, the act 302 can include updating one or more emulated files in an emulated file system, where the one or more emulated files contains the data to transfer from the network processor 204 to the decoder processor 202. The emulated file system can be, for example, an emulated FAT32 file system or an emulated stream-based file system. Other types of emulated file systems could also be used, as well as actual files systems.

The act 302 can alternatively be accomplished by asserting a control signal that is accessible to the master processor. For example, the network processor 204 can assert a control signal on the hardware line 228 that can be detected by the decoder processor 202.

Method 300 also includes an act 304 of determining that data is available for transfer from a slave processor. For example, the decoder processor 202 can determine that data is available for transfer from the network processor 204 to the decoder processor 202.

The act 304 can include polling one or more emulated files in an emulated file system at regular intervals and detecting an update to the one or more emulated files, where the one or more emulated files contains the data to transfer from the slave processor to the master processor. For example, where the data to be communicated is control information, the decoder processor 202 can read one or more emulated control files corresponding to the network processor 204 at regular intervals. When a change to the one or more emulated control files is detected, the decoder processor 202 can determine that control information is available for transfer from the network processor 204 to the decoder processor 202.

The act 304 can alternatively include polling a control signal at regular intervals, or receiving an interrupt associated with the control signal, and detecting that the control signal has been asserted by the slave processor. For example, where the data to be communicated is status information, the decoder processor 202 can check the control signal on the hardware line 228 at regular intervals. When the control signal on the hardware line 228 is asserted, the decoder processor 202 can determine that status information is available for transfer from the network processor 204 to the decoder processor 202.

Method 300 also includes an act 306 of sending a request for the data to the slave processor over a storage-based channel and an act 308 of receiving the request for the data from the master processor over the storage-based channel. For example, the decoder processor 202 can send a request that is received by the network processor 204 for the data associated with acts 302 and 304. This request for the data can be sent and received over the IDE bus 206.

The acts 306 and 308 can include sending and receiving, respectively, a request for the data contained in the one or more emulated files. For example, the network processor 204 can receive a request sent from the decoder processor 202 for the control information contained in the one or more emulated control files, as disclosed in a previous example above.

The acts 306 and 308 can alternatively include sending and receiving, respectively, a request for the data accessed through a specific IDE sector address. For example, the network processor 204 can receive a request sent by the decoder processor 202 for the control information accessed through a specific IDE sector address. The specific IDE sector address can correspond to an IDE sector used by the decoder processor 202 to write data to be communicated to the network processor 204.

Method 300 also includes an act 310 of sending the data to the master processor over the storage-based channel and an act 312 receiving the data from the slave processor over the storage-based channel. For example, the decoder processor 202 can receive the data associated with acts 302-308 that is sent by the network processor 204. This data can be sent and received over the IDE bus 206.

The acts 310 and 312 can include sending and receiving, respectively, the data contained in the one or more emulated files. For example, the network processor 204 can send the control information contained in the one or more emulated control files to the decoder processor 202, as disclosed in previous examples.

Alternatively, the acts 310 and 312 can include sending and receiving, respectively, the data accessed through a specific IDE sector address. For example, the network processor 204 can send the control information accessed through a specific IDE sector address to the decoder processor 202. The specific IDE sector address can correspond to an IDE sector used by the network processor 204 to write data to be communicated to the decoder processor 202.

Method 350 involves communicating information from a master processor to a slave processor. Method 300 can be useful, for example, when the master processor needs to instruct the slave processor to rescan for network servers or to go to low power mode. Method 350 includes an act 352 of detecting an event on a master processor. For example, the decoder processor 202 can detect an event whenever an event occurs on the processor 352. The event can be, for example, a control event or a status event.

One example of a control event is receiving a power down command. A power down command can be generated by a user of the media adapter 200 using a remote control device (not shown). The remote control device can generate an infrared signal that can be received by the decoder processor 202 over a consumer infrared channel 226. Other examples of control events include receiving a power up command, a flush cache command, or an update network settings command.

Method 350 also includes an act 354 of sending data corresponding to the event to a slave processor over the storage-based channel and an act 356 of receiving the data from the master processor over the storage-based channel. For example, the decoder processor 202 can send data corresponding to the power down control event, or other status or control event, that is received by the network processor 204. This data can be sent and received over the IDE bus 206.

The acts 354 and 356 can include sending and receiving, respectively, the data contained in the one or more emulated files in an emulated file system, where the one or more emulated files contain the data to transfer from the master processor to the slave processor. As disclosed elsewhere herein, the network processor 204 can be treated by the decoder processor 202 as an IDE storage device and an emulator can be used to convert storage operations to network and communication operations and vice versa. Thus, the acts 354 and 356 can include sending data to and receiving data at one or more emulated files in an emulated file system, where the one or more emulated files contains the data to transfer from the decoder processor 202 to the network processor 204. The emulated file system can be, for example, an emulated FAT32 file system or an emulated stream-based file system. Other types of emulated file systems could also be used, as well as actual files systems. For example, the decoder processor 202 can send control information contained in the one or more emulated control files to the network processor 204, as disclosed in previous examples.

Alternatively, the acts 354 and 356 can include sending and receiving, respectively, the data accessed through a specific IDE sector address. For example, the decoder processor 202 can send the control information accessed through a specific IDE sector address to the network processor 204. The specific IDE sector address can correspond to an IDE sector used by the decoder processor 202 to write data to be communicated to the network processor 204.

The example methods 300 and 350 therefore enable communication between processors in a dual-processor system. This communication of data can occur over a storage-based channel, such as an IDE bus. The communication of data can occur using either IDE-based sector addresses or using one or more emulated files in an emulated file system.

### IV. Example Inter-Processor Message Block Protocol

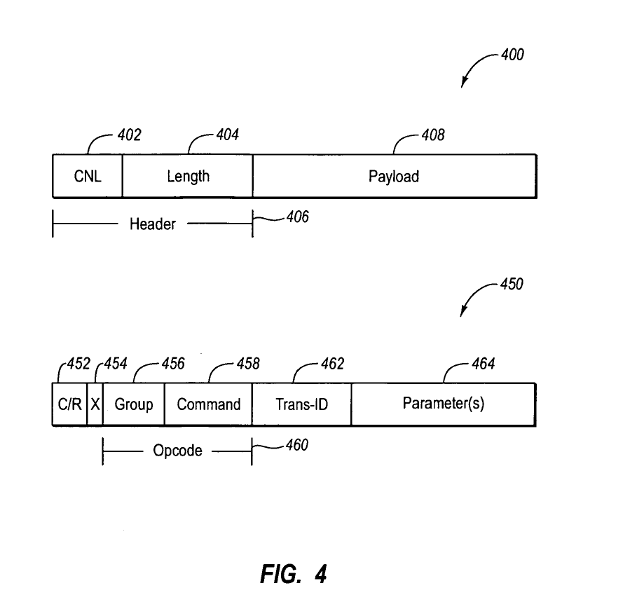

Turning now to FIG. 4, aspects of an example inter-processor message block (IMB) protocol are disclosed. The IMB protocol disclosed in FIG. 4 is an extensible communication language for transferring data, commands, status information and the like in a system having dual processors connected by a storage device type bus, such as the media adapter 200 of FIG. 2. The IMB protocol disclosed in FIG. 4 can be used as an application type protocol layer on top of an IDE transport. For example, the IMB protocol of FIG. 4 can be used when sending any message between the decoder processor 202 and the network processor 204 over the IDE bus 206 in the media adapter 200 of FIG. 2. The IMB protocol can therefore be used in conjunction with the methods 300 and 350 of FIGS. 3A and 3B. In addition, the IMB protocol could be used in other types of systems. For example, the IMB protocol can operate across standard network protocols including, but not limited to, 3G, Bluetooth and the like.

The IMB protocol specifies that each IMB message 400 include a set of virtual data structures including a plurality of data fields that facilitate transferring the IMB message 400 between two processors over a storage-based channel. The IMB message 400 includes a channel field 402 and a length field 404 which together make up a header 406. The IMB message also includes a payload field 408.

The channel field 402 is a 3-bit field which specifies the virtual IMB channel that the IMB message 400 is transferred over. The channel field 402 may also be used to indicate the level-two protocol contained within the payload field 408 of the IMB message 400. The term “level-two protocol” as used herein refers to an application protocol that is transported within the payload field 408 of the IMB message 400. One example of a level-two protocol is an AOE request 450, described below. The channel field 402 may also be used to indicate the semantics of the delivery of the IMB message 400. The size of the channel field 402 allows for 8 channels. Channels are predefined values and there can be up to 8 channels specified. Each channel is discrete and there are no interdependencies between channels. The channel field 402 occupies header bits 0-2. The following example values are defined:

000b—Asynchronous Opcode Exchange.

001-111b—Other channels reserved for future use.

The length field 404 is a 13-bit field that specifies the length of the payload field 408 of the 1 MB message 400. The length field 404 occupies header bits 3-15. An IMB message 400 of length zero and channel zero can be used to indicate the end of valid data in a receive buffer stream.

The payload field 408 contains zero or more bytes of layer two protocol data starting at bit 16. The format of the data is identified by the channel field 402.

The design of the IMB message 400 permits multiple IMB messages to be transferred in one transport read or write. In one example embodiment, when transferring IMB messages via IDE sectors, every IMB message must fit completely within one IDE sector. One current IDE sector definition limits the maximum IMB payload field 408 size to 510 bytes. Multiple IMB messages may be concatenated into one IDE sector when their combined size is less than or equal to 512 bytes. However, every IMB message must still include the full IMB header 406. IMB messages from different channels may be combined and transferred in one transport read or write.

Continuing with the example embodiment above, when a partial IDE sector is transferred, two bytes of zero must be encoded after the final IMB message to signal “end-of-IMB-messages.” This rule applies even if the sector includes only one IMB message. If the partial sector is 511 bytes, only one byte of zero must be encoded.

FIG. 4 also discloses one example use for an IMB message 400. In particular, an IMB message 400 can be used to send an asynchronous opcode execution (AOE) request 450. An AOE request 450 is used to invoke a procedure on the target subsystem. For example, the AOE request 450 can be used by the network processor 204 to invoke a procedure on the decoder 202 processor. The AOE protocol of the AOE request 450 provides for exchange of a procedure opcode and all parameters/data associated with the procedure. The AOE request 450 can be contained within the payload field 408 of an IMB message 400. In one example implementation, an IMB message can contain one AOE request 450. In another example implementation, an IMB message can contain multiple AOE requests

As disclosed in FIG. 4, the protocol of the AOE request 450 specifies that each AOE request 450 include a set of virtual data structures including a plurality of data fields that facilitate invoking a procedure on a target subsystem. The AOE request 450 includes a command response mode field 452 and a reserved field 454. The AOE request 450 also includes a group field 456 and a command field 458, which together make up an opcode filed 460. The AOE request 450 also includes a transaction identifier field 462 and one or more parameter fields 464.

The command response mode field 452 is the first two bits of the AOE request 450 and specifies the Command/Response mode of the AOE request 450. The value of this field does not affect the opcode. The following example values are defined:
00b—This opcode is a response to a received command. The transaction identifier field 462 must be set to the value received in the original command.
11b—This opcode is a command and a response must be sent.

01b—This opcode is a command and a response must be sent only if it indicates non-successful status.
10b—This opcode is a command and a response must not be sent.

The reserved field 454 is a 1-bit field and is reserved for future used. It must be set to zero by the sender and ignored by the receiver.

The group field 456 is a 5-bit field that indicates the functional group that this command belongs to. Groups are used to direct commands to the appropriate group handler. They are also used for advanced features such as ‘command flush on error,’ described in greater detail below. The length of the IMB group field 456 allows for up to 32 groups.

The command field 458 is an 8-bit field that indicates the function or procedure to execute on the receiving subsystem. Each group defines its own set of commands. There can be up to 256 commands per group.

The combination of a command field 458 and a group field 456 form an opcode field 460. The opcode specifies both the command and the group to which it belongs. Each opcode defines its own parameters and behavior. For each opcode, the number of parameters, as well as their type and order is fixed. If a change to an opcode parameter list is necessary, a new opcode must be assigned to this new version of the function.

The transaction identifier field 462 is an 8-bit field that is provided by the requestor to uniquely identify the transaction. The value is opaque to the AOE protocol. If a response is sent, it must carry the transaction id of the command.

The format, order and number of the one or more parameter fields 464 are based on the specific opcode field 460. Parameters are encoded in the message in the same order as they are provided to the function call. The following rules apply to encoding parameters:
1. BOOL, 8 bit and char types are encoded as a single byte.
2. 16 and 32 bit values are encoded in 4 bytes in big-endian order.
3. Strings, arrays and buffers are encoded with a 2 byte length prefix. String values must no include a null-terminator in their encoding.
4. The type, order and quantity of parameters for each opcode are fixed and well-known.

Operations within the AOE protocol associated with the AOE request 450 are governed by the following operating procedures.
1. Logical collections of commands are isolated into groups. Each group may be serviced by one or more processes, or multiple groups may be serviced by a single process. Each message within the AOE group must be processed completely before advancing to the next message. This synchronization requirement spans all AOE groups.
2. When a response is sent to a command, it must include the same opcode (Group and Command) as was received in the corresponding command. A response must not be sent until the command has completed on the receiving device.
3. When sending an unsolicited result, the transaction identified field 462 should be set to “zero”. The recipient of such a message should interpret this as an unsolicited indication.
4. The IMB and AOE protocols support ignoring or ‘flushing’ messages as an error recovery mechanism. Flushing is a group specific feature and not all groups will support it. When flushing, the group handler discards all received messages until a group specific re-sync message has been received. The following guidelines can be used for a group with command flushing capability.
   a. A failure response should be sent for the command that caused the error which results in subsequent command flushing.
   b. A flush indication message must be sent to the group whose command caused the local group handler to enter the flushing state. The flush indication opcode must require a result.
   c. The recipient of a flush indication message must send a flush result to resume normal command processing. The flush result must report success. If recovery steps are necessary, they are sent after the flush result message.
   d. When in the flushing state, the opcode of each command must be checked for the flush result message. Upon reception of the flush result message, normal command processing shall resume.
   e. When in the flushing state, if a command with the C/R flag ‘response required’ or ‘response on error’ is flushed, it is optional to send a result. If a result is sent, a failure response indicating that the command was flushed must be used.
   f. The flush and flush result messages, along with their parameters if any, are group specific.

The following charts describe opcodes that have been defined for use with the designated group. For each opcode the parameters sent over the IMB channel are specified along with their transfer types. Opcodes with no corresponding response are identified by the response parameter “none”.

| | Value | Description |
|---|---|---|
| Group | | |
| Control | 0 | Control and debug message output |
| Command | | |
| Debug Print | 0 | Sent by the encoding processor to write a debug |
| | | message to the network processor debug port. |
| | | Request: char message[ ] |
| | | Response: none |
| Debug Print | 1 | Sent by the encoding processor to write a debug |
| Parameters | | message to the network processor debug port. The |
| | | message consists of a format string and from 0 to 5 |
| | | parameters. Each parameter must be sent in the |
| | | AOE buffer format. |
| | | Request: char format[ ], . . . |
| | | Response: none |

| Group | Value | Description |
|---|---|---|
| Display | 1 | On Screen Display service |

| | Value | Description |
|---|---|---|
| Group | | |
| Firmware Update | 2 | Firmware update service |
| Command | | |
| Notify | 0 | Sent by the network processor to notify the encoding |
| | | processor that a firmware update image is available. The |
| | | encoding processor is expected to interact with the user |
| | | to select the best course of action. |
| | | Request: u8 description[ ], U8 date[ ] |
| | | Response: u32 action (enumeration) |
| Wire Firmware | 1 | Sent by the network processor to write the firmware |
| | | image data to temporary storage. |
| | | Request: U8 buffer[ ] |
| | | Response: u32 result |
| Write Firmware | 2 | Sent by the network processor to notify the recipient that the |
| Done | | entire firmware image has been written. The |
| | | recipient may use this opportunity to validate the image. |
| | | The response is use to inform the originator of the status |
| | | of the image. |
| | | Request: void |
| | | Response: u32 result |
| Abort Firmware | 3 | Sent by the network processor or the encoding processor |
| Update | | to request canceling of the update and flushing of all |
| | | received firmware image data. This function is called if |
| | | an error occurs during firmware download process. It |
| | | may be called at any stage of the process, until reboot. |
| | | Request: void |
| | | Response: u32 result - must be success! |
| Setup Update | 4 | Sent by the network processor to setup the encoding |
| | | processor to receive a firmware image. |
| | | Request: u32 CRC, u32 image_size |
| | | Response: u32 result |
| Commit Update | 5 | Sent by the network processor to commit the encoding |
| | | processor update to flash. This operation is performed |
| | | after both images have been verified. This is the point of |
| | | no return. |
| | | Request: void |
| | | Response: none |

### V. Example Asynchronous Opcode Application Environment

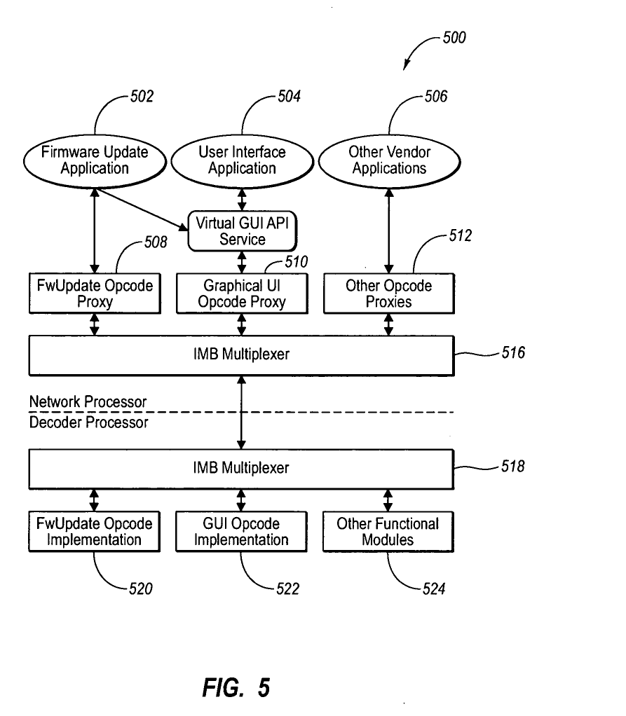

Turning now to FIG. 5, an example asynchronous opcode application environment 500 is disclosed. Although the AOE protocol associated with the AOE request 450 of FIG. 4 does not mandate a specific application environment, the following application environment model is provided to elaborate on the overall AOE architecture.

There are several components in the AOE application environment 500. Each of the applications 502-504 implements the required functionality by making use of one or more proxies and/or services 508-514. Services, such as service 514, provide a robust local API that builds upon lower layer opcodes. Proxies, such as proxies 508-512, expose the remote sub-system opcodes as asynchronous functions.

Each of the IMB multiplexers 516 and 518 packages, transmits, receives, decodes and dispatches IMB messages. In this illustration, each of the IMB multiplexers 516 and 518 switches based on opcode group 520-524.

### VI. Example Asynchronous Opcode Programming Interface

In one example embodiment, a proxy user must register with the IMB to send and receive messages. The proxy user will provide a registration structure that includes a callback function for each opcode supported locally. These callbacks are used to dispatch received commands and responses to the proxy user.

When calling a remote procedure, the caller invokes a stub function on the local processor. This stub function will move all of the function parameters into a transmit buffer along with the opcode and other message fields. The message is then transferred to the companion unit for processing. Upon reception of the message, the callee will decode the opcode and execute the corresponding function on the local processor.

If the method does not return any values to the caller the operation is complete once the function call returns. At this point the next method received is executed, and so on.

If the method returns a status value or other information, the callee packages the results in an IMB-AOE with the same opcode (but with the result C/R bits set) and sends the message back to the caller. Upon reception of the result opcode, the library issues a callback to the proxy user's callback handler with the result data.

A local library will track all outstanding (unacknowledged, non-void return) function calls. The use of a transaction identifier field 462 helps to match commands with results, and helps to support the optional omission of sending positive status-only acknowledgements.

The example methods 300 and 350 of FIGS. 3A and 3B and the example aspects of the IMB protocol of FIG. 4 and the AOE protocol of FIG. 5 can be implemented using computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment including a master processor and a slave processor, a method for the slave processor to communicate with the master processor, the method comprising the acts of:
indicating to a master processor that data is available to transfer to the master processor;
receiving a request for the data from the master processor over a storage-based channel; and
sending the data to the master processor over a storage-based channel.

2. The method as recited in claim 1, wherein the data is at least one of status information, control information, hardware settings information, firmware update information, content data, directory information, or rendering directives.

3. The method as recited in claim 1, wherein the act of indicating to a master processor that data is available to transfer to the master processor is performed in response to an event that changes the data.

4. The method as recited in claim 1, wherein the act of indicating to a master processor that data is available to transfer to the master processor comprises updating one or more emulated files in an emulated file system, the one or more emulated files containing the data to transfer from the slave processor to the master processor.

5. The method as recited in claim 4, wherein receiving a request for the data from the master processor over a storage-based channel comprises receiving a request for the data contained in the one or more emulated files.

6. The method as recited in claim 1, wherein the act of indicating to a master processor that data is available to transfer to the master processor comprises asserting a control signal that is accessible to the master processor.

7. The method as recited in claim 6, wherein receiving a request for the data from the master processor over a storage-based channel comprises receiving a request for the data accessed through a specific IDE sector address.

8. In a computing environment including a master processor and a slave processor, a method for the master processor to communicate with the slave processor, the method comprising the acts of:
determining that data is available for transfer from a slave processor;
sending a request for the data to the slave processor over a storage-based channel; and
receiving the data from the slave processor over a storage-based channel.

9. The method as recited in claim 8, wherein the data is at least one of status information, control information, hardware settings information, firmware update information, content data, directory information, or rendering directives.

10. The method as recited in claim 8, wherein the act of determining that data is available for transfer from a slave processor comprises:
polling one or more emulated files in an emulated file system at regular intervals, the one or more emulated files containing the data to transfer from the slave processor to the master processor; and
detecting an update to the one or more emulated files.

11. The method as recited in claim 10, wherein the act of sending a request for the data to the slave processor over a storage-based channel comprises sending a request for the data contained in the one or more emulated files.

12. The method as recited in claim 8, wherein the act of determining that data is available for transfer from a slave processor comprises:
detecting that a control signal has been asserted by the slave processor.

13. The method as recited in claim 12, wherein sending a request for the data to the slave processor over a storage-based channel comprises sending a request for the data accessed through a specific IDE sector address.

14. In a computing environment including a master processor and a slave processor, a method for the master processor to communicate information to the slave processor, the method comprising the acts of:
detecting an event on a master processor; and
sending data corresponding to the event to a slave processor over a storage-based channel.

15. The method as recited in claim 14, wherein detecting an event on a master processor comprises detecting at least one of a control event or a status event on the master processor.

16. The method as recited in claim 14, wherein writing data corresponding to the event to a slave processor over a storage-based channel comprises writing data corresponding to the event to one or more emulated files in an emulated file system, the one or more emulated files containing data to transfer from the master processor to the slave processor.

17. The method as recited in claim 14, wherein writing data corresponding to the event to a slave processor over a storage-based channel comprises writing data corresponding to the event to a specific IDE sector address accessing data to transfer from the master processor to the slave processor.

18. In a computing environment including a plurality of processors, one or more computer readable media including a plurality of data fields that facilitate transferring an inter-processor message block message between two processors over a storage-based channel, the computer readable media comprising:
a first virtual data structure comprising:
a virtual first data field comprising a channel field designating a storage-based channel over which the associated message is transferred;
a virtual second data field comprising a length field designating the length of a payload portion of the message; and
a virtual third data field comprising a payload field comprising zero or more bytes of layer two protocol data.

19. The computer readable media as recited in claim 18, wherein the virtual first data field further designates the specific level-two protocol of any layer two protocol data contained within the virtual third data field.

20. The computer readable media as recited in claim 18, wherein the computer readable media further comprises a second virtual data structure, the structure of the second virtual data structure being identical to the first virtual data structure, wherein the second virtual data structure is concatenated to the first virtual data structures.

21. The computer readable media as recited in claim 20, wherein the storage-based channel designated in the virtual first data field of the first virtual data structure is different from the channel designated in the virtual first data field of the second virtual data structure.

22. The computer readable media as recited in claim 18, wherein the computer readable media further comprise a fourth data field comprising an end-of-block signal which signals the end of the message.

23. The computer readable media as recited in claim 18, wherein the virtual third data field further designates an asynchronous opcode execution request that facilitates invoking a procedure on a target subsystem, the virtual third data field comprising:
a command response mode field designating the mode of a command or response contained in the message;
an opcode field comprising:
a group field indicating the function group to which a command contained in the message belongs; and
a command field indicating a function or a procedure to execute on the receiving processor;
a transaction identifier field indicating a unique identifier for the transaction; and
one or more parameter fields each of which corresponds to the opcode field.
